(19) United States
(12) Patent Application Publication
(10) Pub. No.: US 2019/0374804 A1
(43) Pub. Date: Dec. 12, 2019

(54) COMPOSITIONS FOR FIRE SUPPRESSANT POWDERS

(71) Applicant: Halliburton Energy Services, Inc., Houston, TX (US)

(72) Inventor: Preston Andrew May, Porter, TX (US)

(73) Assignee: Halliburton Energy Services, Inc., Houston, TX (US)

(21) Appl. No.: 16/002,762

(22) Filed: Jun. 7, 2018

(51) Int. Cl. A62D 1/00; A62C 13/00; A62C 13/64

(52) U.S. Cl. CPC A62D 1/0014; A62C 13/64; A62C 13/006; A62C 13/003

(57) ABSTRACT

An apparatus may comprise: a vessel, a fire-suppression composition disposed within the vessel, wherein the fire-suppression composition comprises a fibrous clay mineral and a propellant gas; and a valve disposed on an outlet of the vessel wherein the valve has at least an open position with a flow path between an interior of the vessel and an exterior of the vessel and a closed position wherein the flow path is blocked.

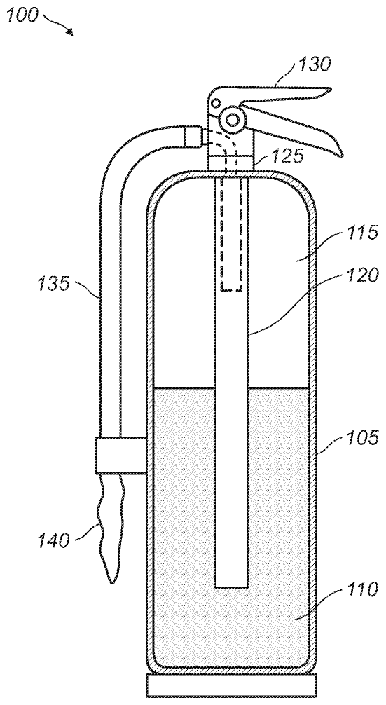

### BACKGROUND

Fires in industrial and residential settings may pose an extreme risk to life and property. Heat, smoke, and toxic compositions derived from fires may be physically destructive to property and structures as well as pose acute health risks to humans and other living organisms. Fire is the result of combustion, a high-temperature exothermic redox reaction between a fuel and an oxidant. A fire may involve a multitude of fuels such as solid materials, liquid materials, gasses, and metals as well as a multitude of oxidants such as air, gaseous oxidants, liquid oxidants, and solid oxidants. A combustion reaction between any individually selected fuel and oxidizer may exhibit individual characteristics that may make the resulting fire relatively more or less dangerous or difficult to extinguish.

Four components are necessary to sustain any fire: fuel, oxidant, heat, and an uninhibited chemical chain reaction. It thus follows that a fire may be extinguished by at least one of removing the fuel, removing or excluding the oxidant, removing heat from the fire, and inhibiting the chemical chain reaction. Fire-fighting techniques and compositions may suffer from several drawbacks in to extinguishing the fire, including, but not limited to, high cost of installation or operation, little to no binding to a target area, little to no removal of heat from fire, environmental or toxicity concerns, inadequate quenching or inhibition of oxidant, and inadequate discharge of the of fire-suppressant compositions from a fire-fighting apparatus, among other concerns. Furthermore, some fire extinguisher formulations may be toxic to users. For example, halogen-based formulations may extinguish fires by interrupting the chemical chain reaction, but the smoke generated from these compounds is toxic. Aqueous film forming foams (AFFFs) often incorporate toxic fluorosurfactants such as perfluorooctane sulfonate, which can contaminate groundwater and living organisms.

### BRIEF DESCRIPTION OF THE DRAWINGS

This drawing illustrates certain aspects of some of the embodiments of the present disclosure, and should not be used to limit or define the scope of this disclosure.

The FIGURE is a schematic illustration of a fire extinguisher.

### DETAILED DESCRIPTION

In some compositions, methods, and systems described herein, a fire-suppressant composition comprising fibrous clay minerals may be used to extinguish fires. Fibrous clay minerals may provide desirable properties in fire extinguishing including environmental compatibility, low toxicity, rapid heat removal, and low cost. Additionally, fibrous clay minerals may present increased, ability to flow and adequately discharge from a fire-suppression apparatus as compared to compositions comprising other clays such as, for example, bentonite with non-fibrous morphology.

Fibrous clay minerals may be characterized as a hydrated magnesium silicate clays or hydrated magnesium aluminum silicate clays. Fibrous clay minerals may have an empirical formula of Mg₄Si₆O₁₅(OH)₂.6H₂O or (Mg,Al)₂ Si₄O₁₀(OH).4H₂O, for example. Some fibrous clay minerals may include, but are not limited to, sepiolite, palygorskite, or attapulgite. Compared to other fire-suppression compositions, fibrous clay minerals may be more economical. Furthermore, various grades of fibrous clay minerals may be used that are relatively more or less economical depending on the processing steps taken to produce the fibrous clay mineral powder. Some fibrous clay mineral samples may be milled less than other samples and therefore may have a larger median particle size (D50) and a broader particle size distribution. A fibrous clay mineral powder that is not as finely milled may be relatively less expensive to produce than a fibrous clay mineral powder that is finely milled, allowing for less expensive production.

Fire-suppressant compositions comprising bentonite and aluminum hydroxide have been used successfully in fire extinguishers. However, bentonite may, in certain applications, present a reduced ability to flow without clogging an orifice or other restriction such as when discharging the mineral from a fire extinguisher. As will be discussed in the example section below, bentonite may flow well at low total mass flows but may have reduced ability to flow as the total mass is increased. As one of ordinary skill in the art will appreciate, bentonite clays vary in composition and morphology depending on the source where the clay was mined. The morphology of bentonites may vary, without limitation, from corn-flake, maple leaf, honeycomb, plate-like, scalloped, sponge-like, cellular, and ribbon-like, among many others.

Fibrous clay minerals such as sepiolite, palygorskite, and attapulgite may have elongated and needle-like morphology. Without being limited by theory, when the fibrous clay minerals are dispersed, the fibers may overlap and interlink thereby creating a low permeability matted network. The low permeability matted network may present a barrier to oxygen, for example, and thus provide an effective fire-suppressant.

It follows that the matting effects associated with fibrous clay minerals should also provide a restriction or reduction in flowability as compared to bentonite which has a generally more spherical morphology as compared to fibrous clay minerals. However, as will be illustrated in the example section below, the fibrous clay minerals may present an enhanced ability to flow when compared to bentonite.

Various examples of the present disclosure may provide a fire-suppression apparatus and method of fire-fighting. The fire-suppression apparatus may comprise a vessel containing a propellant gas and a fire-suppressant composition comprising fibrous clay minerals, a discharge nozzle, a valve positioned between an outlet of the vessel and the discharge nozzle, and a means for controlling the position of the valve. A method of fire-fighting may comprise discharging the fire-suppression apparatus to contact at least one of a fire and the source of the fire (e.g., the fuel source that burns to produce the flames of the fire) with the fire-suppressant composition comprising fibrous clay minerals. The contacting may be sufficient to extinguish at least part of the fire or decrease the intensity of at least part of the fire. The contacting may be of sufficient magnitude and duration such that at least some extinguishing or decrease in intensity of the fire occurs.

The fire-suppressant composition comprising fibrous clay minerals may be any suitable for use with any type of fire. In some examples, the fire may include at least one of a U.S. Class A fire (e.g., including ordinary combustibles such as wood, paper, fabric, plastic, or trash), a U.S. Class B fire (e.g., including flammable or combustible liquid or gas), a U.S. Class C fire (e.g., an electrical fire including energized or potentially energized electrical equipment), a U.S. Class D fire (e.g., a metal fire, including materials such as magnesium, potassium, titanium, or zirconium), and a U.S. Class K fire (e.g., cooking oils).

Without being limited by theory, it is believed that fibrous clay minerals displace an oxidant, such as air, from the fire to suppress and/or extinguish the fire. However, examples of the fire-suppressant composition are not limited to any particular mechanism of action; any suitable mechanism of action to inhibit or extinguish fires may occur during the method. In various examples, the fire-suppressant composition comprising fibrous clay minerals may present a barrier to oxygen and absorb heat from a fire. The oxygen may have reduced access to the burning material by the physical separation of oxygen from the fire. Fibrous clay minerals may at least partially isolate the fire from oxygen when it is spread over the source of the fire by blocking the interface between fuel and the surrounding air. Fibrous clay minerals may also partially or fully dehydrate on contact with elevated temperatures. Dehydration of fibrous clay minerals may release water molecules which may act to further smother and cool fire. Without being limited by theory, water molecules associated with fibrous clay minerals may be less tightly bound to the fibrous clay structure compared to other swelling clays such as, for example, bentonite. Weaker association may require less thermal energy input to release the water molecules from the fibrous clay mineral. As will be discussed in further detail below, the fire-suppressant composition may further comprise at least one of bentonite and aluminum hydroxide. In fire-suppressant compositions comprising bentonite and aluminum hydroxide, the aluminum hydroxide may remove heat via an endothermic dehydration reaction. 3Al(OH)₃ may degrade to Al₃O₂+3H₂O. Degradation of aluminum hydroxide may cause flame retardation and smoke suppression. As fuel for the fire is cooled below its combustion point, the fire may be inhibited from spreading. The bentonite may also absorb heat as it dehydrates, with thermal energy being absorbed as interlayer water and lattice water are removed.

In some examples, water released from the aluminum hydroxide or fibrous clay minerals may partially hydrate the bentonite to create an aqueous gel. The aqueous gel may increase in viscosity, which may prevent runoff of targeted areas. This may localize cooling effects and minimize the required volume of extinguishing media. The gel can additionally enhance the smothering of the blend by further reducing fuel-air contact.

The fire-suppressant composition may comprise fibrous clay minerals alone, or fibrous clay minerals in combination with other compounds. For example, the fire-suppression composition may comprise fibrous clay minerals, fibrous clay minerals and bentonite, or fibrous clay minerals, bentonite, and aluminum hydroxide, for example.

The fire-suppression composition may comprise fibrous clay minerals in any amount suitable for a particular application. The fire-suppression composition may comprise sepiolite, palygorskite, attapulgite, or combinations thereof. For example, the fire-suppression composition may consist essentially of fibrous clay minerals with no additional components. Alternatively, the fire-suppression composition may comprise additional components such that the fibrous clay minerals may be present at a point ranging from about 50 wt. % to about 99.99 wt. % based on the total weight of the fire-suppressant composition. Alternatively, a point ranging from about 50 wt. % to about 60 wt. %, a point ranging from about 60 wt. % to about 70 wt. %, a point ranging from about 70 wt. % to about 80 wt. %, a point ranging from about 80 wt. % to about 90 wt. %, a point ranging from about 90 wt. % to about 95 wt. %, a point ranging from about 95 wt. % to about 99 wt. %, or a point ranging from about 99 wt. % to about 99.99 wt. %. The fibrous clay minerals may be included in the fire-suppression composition at any point within the stated ranges.

The fibrous clay minerals may have any suitable particle size or distribution for a particular application. The fibrous clay minerals may have a d50 particle distribution in a range of from about 10 microns to about 600 microns. The d50 values may be measured by particle size analyzers such as those manufactured by Malvern Instruments, Worcestershire, United Kingdom. A d50 particle size distribution is also known as the median diameter or the medium value of the particle size distribution, it is the value of the particle diameter at 50% in the cumulative distribution. For example, if d50=100 microns, then 50% of the particles in the sample are larger than 100 microns and 50% smaller than 100 microns. Alternatively, the fibrous clay minerals may have a d50 particle size at a point ranging from about 10 microns to about 100 microns, at a point ranging from about 20 microns to about 200 microns, at a point ranging from about 100 microns to about 200 microns, at a point ranging from about 200 microns to about 300 microns, at a point ranging from about 300 microns to about 400 microns, at a point ranging from about 400 microns to about 500 microns, or at point in a range of about 500 microns to about 600 microns.

The fire-suppression composition may comprise bentonite. The bentonite may comprise include at least one of sodium bentonite, calcium bentonite, and montmorillonite. The bentonite may be substantially sodium bentonite. The bentonite may be untreated sodium bentonite clay or untreated Wyoming sodium bentonite clay. The bentonite may comprise additional constituents such as, for example, feldspar (e.g., potassium feldspar or plagioclase), quartz, gypsum, dolomite, illite, mica, calcite, opal, dolomite, siderite, and clinoptilolite. For example, the bentonite may comprise additional elements at a point ranging from about 5 wt. % to about 20 wt. % of the bentonite. Alternatively, at a point ranging from about 5 wt. % to about 10 wt. %, at a point ranging from about 10 wt. % to about 15 wt. %, or at a point ranging from about 15 wt. % to about 20 wt. %.

The fire-suppression composition may comprise bentonite in any amount suitable for a particular application. For example, the fire-suppression composition may comprise bentonite at a point ranging from about 1 wt. % to about 20 wt. %, a point ranging from about 1 wt. % to about 5 wt. %, a point ranging from about 5 wt. % to about 10 wt. %, a point ranging from about 10 wt. % to about 15 wt. %, or a point ranging from about 15 wt. % to about 20 wt. % based on a total weight of the fire-suppression composition. The bentonite may be included in the fire-suppression composition at any point within the stated ranges.

The bentonite may have any suitable particle size or distribution for a particular application. The bentonite may have a d50 particle distribution in a range of from about 10 microns to about 600 microns. Alternatively, the bentonite may have a d50 particle size at a point ranging from about 10 microns to about 100 microns, at a point ranging from about 20 microns to about 200 microns, at a point ranging from about 100 microns to about 200 microns, at a point ranging from about 200 microns to about 300 microns, at a point ranging from about 300 microns to about 400 microns, at a point ranging from about 400 microns to about 500 microns, or at point in a range of about 500 microns to about 600 microns.

The fire-suppression composition may comprise aluminum hydroxide. The aluminum hydroxide may be from any suitable source of aluminum hydroxides, such as, without limitation, gibbsite, bayerite, doyelite, nordstrandite, and combinations thereof. The aluminum hydroxide may be hydrated or dehydrated, for example as Al(OH)₃ or Al₂O₃.3H₂O. Aluminum hydroxide may be present in the fire-suppression composition in any suitable amount for a particular application. For example, the aluminum hydroxide may be present at a point ranging from about 5 wt. % to about 50 wt. %, a point ranging from about 5 wt. % to about 10 wt. %, a point ranging from about 10 wt. % to about 20 wt. %, a point ranging from about 20 wt. % to about 30 wt. %, a point ranging from about 30 wt. % to about 40 wt. %, or a point ranging from about 40 wt. % to about 50 wt. % based on a total weight of the fire-suppression composition. The aluminum hydroxide may be included in the fire-suppression composition at any point within the stated ranges.

The aluminum hydroxide may have any suitable particle size or distribution for a particular application. The aluminum hydroxide may have a d50 particle distribution ranging from about 10 microns to about 600 microns. Alternatively, the bentonite may have a d50 particle size at a point ranging from about 10 microns to about 100 microns, at a point ranging from about 20 microns to about 200 microns, at a point ranging from about 100 microns to about 200 microns, at a point ranging from about 200 microns to about 300 microns, at a point ranging from about 300 microns to about 400 microns, at a point ranging from about 400 microns to about 500 microns, or at point in a range of about 500 microns to about 600 microns.

Where present, the ratio of the mass of the bentonite to the mass of the aluminum hydroxide can be any suitable ratio, such as, for example, about 0.1:1 to about 10:1 bentonite to aluminum hydroxide. Alternatively, about 0.1:1 to about 1:1, about 1:1 to about 3:1, about 3:1 to about 6:1, or about 6:1 to about 10:1.

The fire-suppressant composition may further comprise one or more flow agents or anticaking agents. The flow agent or anticaking agent can be any suitable flow agent or anticaking agent, such as at least one of silica, sodium silicate, calcium silicate, tricalcium phosphate, sodium bicarbonate, potassium bicarbonate, magnesium trisilicate, talc, sodium aluminosilicate, potassium aluminosilicate, calcium aluminosilicate, aluminum silicate, polydimethylsiloxane, and combinations thereof. The additives may be present in the fire-suppressant composition any amount suitable for a particular application. For example, the additives may be present at a point in ranging from about 0.1 wt. % to about 10 wt. % based on a total weight of the fire-suppressant composition. Alternatively, at a point ranging from about 0.1 wt. % to about 0.5 wt. %, at a point ranging from about 0.5 wt. % to about 1 wt. %, at a point ranging from about 1 wt. % to about 3 wt. %, at a point ranging from about 3 wt. % to about 5 wt. %, or at a point ranging from about 5 wt. % to about 10 wt. %.

The fire-suppressant composition may further comprise a dry powder fire suppressant additive. For example, the fire-suppressant composition may further comprise at least one of an alkali metal bicarbonate (e.g., sodium bicarbonate or potassium bicarbonate), potassium chloride, an ammonium phosphate (e.g., monoammonium phosphate), a calcium phosphate (e.g., tricalcium phosphate), an addition product of urea with an alkali metal bicarbonate (e.g., with sodium bicarbonate or potassium bicarbonate), a silicone, and mica. The dry powder fire suppressant additive may be present in the fire-suppressant composition any amount suitable for a particular application. For example, a dry powder fire suppressant additive may be present at a point ranging from about 1 wt. % to about 40 wt. % based on a total weight of the fire-suppressant composition. Alternatively, at a point ranging from about 1 wt. % to about 5 wt. %, at a point ranging from about 5 wt. % to about 10 wt. %, at a point ranging from about 10 wt. % to about 20 wt. %, at a point ranging from about 20 wt. % to about 30 wt. %, or at a point ranging from about 30 wt. % to about 40 wt. %.

The fire-suppressant composition may be in the form of a flowable powder not suspended in a fluid media. The fire-suppression apparatus may comprise a propellant gas that fluidizes and expels the fire-suppressant composition when the valve of the fire-suppression apparatus is actuated.

The propellant gas may be any propellant gas suitable for fire-suppression use. The propellant gas should generally not be flammable itself, nor provide an oxidant to the fire such as air or oxygen. Some examples of suitable propellant gasses may include, without limitation, carbon dioxide, nitrogen, noble gasses, helium, and combinations thereof. The propellant gas may be present in the fire-suppression apparatus at any pressure suitable for a particular propellant gas and application. For example, the propellant gas may be present at a pressure at a point ranging from about 500 kPa to about 6000 kPa. Alternatively, the propellant gas may be present at a pressure at a point ranging from about 500 kPa to about 2000 kPa, at a point ranging from about 2000 kPa to about 4000 kPa, or at a point ranging from about 4000 kPa to about 6000 kPa.

In some examples, prior to contacting with a fire or source thereof, the fire-suppressant composition may comprise little to no water that is uncomplexed and unincorporated into any crystalline lattice structure of one or more components of the fire-suppressant composition. In some examples, the fire-suppressant composition may comprise less than about 1 wt. % uncomplexed water based on a total weight of the fire suppressant composition. Alternatively, the fire-suppressant composition may comprise less than about 5 wt. % uncomplexed water, less than about 10 wt. % uncomplexed water, or about 0% uncomplexed water.

Reference will now be made to the FIGURE which illustrates fire-suppression apparatus 100. Fire-suppression apparatus 100 may comprise a body 105 which encloses a volume which fire-suppression composition 110 may be disposed. Fire-suppression composition 110 may be any of the fire-suppression compositions previously disclosed herein. A volume above fire-suppression composition 110 may be filled with a propellant gas 115 which may be any of the previously disclosed propellant gasses. Alternatively, propellant gas 115 may be provided by an integral gas cartridge (not illustrated). A siphon tube 120 may extend from valve 125 into body 105. Valve 125 may be normally closed such that fire-suppression composition 110 and propellant gas 115 remains contained in body 105 during storage. When valve 125 is open, siphon tube 120 in conjunction with valve 125, hose 135 and nozzle 140 may provide a flow path for fire-suppression composition 110 to exit from body 105. Operating lever 130 may be operable to actuate valve 125 into an open position such that the flow path is opened, allowing fire-suppression composition 110 and propellant gas 115 to flow through the flow path. Propellant gas 115 may entrain and fluidize fire-suppression composition 110, thereby allowing the entrained particles of fire-suppression composition 110 to be expelled from fire-suppression apparatus 100.

Accordingly, the present disclosure may be practiced according to one or more of the following statements.

Statement 1. An apparatus comprising: a vessel, a fire-suppression composition disposed within the vessel, wherein the fire-suppression composition comprises a fibrous clay mineral and a propellant gas; and a valve disposed on an outlet of the vessel wherein the valve has at least an open position with a flow path between an interior of the vessel and an exterior of the vessel and a closed position wherein the flow path is blocked.

Statement 2. The apparatus of statement 1 wherein the fibrous clay mineral is selected from the group consisting of sepiolite, palygorskite, attapulgite, and combinations thereof.

Statement 3. The apparatus of any of statements 1 or 2 wherein the fibrous clay mineral has a d50 particle size ranging from about 10 microns to about 600 microns.

Statement 4. The apparatus any of statements 1-3 wherein the propellant gas is selected from the group consisting of nitrogen, carbon dioxide, a noble gas, helium, and combinations thereof, and wherein the propellant gas is at a pressure ranging from about 500 kPa to about 6000 kPa.

Statement 5. The apparatus of any of statements 1-4 wherein the fire-suppression composition further comprises bentonite.

Statement 6. The apparatus of any of statements 1-5 wherein the bentonite has a d50 particle size at a point ranging from about 10 microns to about 600 microns.

Statement 7. The apparatus of any of statements 1-6 wherein the fire-suppression composition further comprises aluminum hydroxide, wherein the aluminum hydroxide has a d50 particle size at a point ranging from about 10 microns to about 600 microns.

Statement 8. The apparatus of any of statements 1-7 wherein the fibrous clay mineral comprises sepiolite, wherein the sepiolite has a d50 particle size ranging from about 20 microns to about 200 microns, and wherein the propellant gas is nitrogen or carbon dioxide.

Statement 9. The apparatus of any of statements 1-8 wherein the fire-suppression composition further comprises a flow agent selected from the group consisting of silica, sodium silicate, calcium silicate, tricalcium phosphate, sodium bicarbonate, potassium bicarbonate, magnesium trisilicate, talc, sodium aluminosilicate, potassium aluminosilicate, calcium aluminosilicate, aluminum silicate, polydimethylsiloxane, and combinations thereof.

Statement 10. The apparatus of any of statements 1-9 wherein the fire-suppression composition further comprises a dry powder fire suppressant additive selected from the group consisting of alkali metal bicarbonate, potassium chloride, ammonium phosphate, calcium phosphate, an addition product of urea with an alkali metal bicarbonate, a silicone, mica, and combinations thereof.

Statement 11. A method comprising: actuating a valve to open a flow path between an interior of a vessel and an exterior of the vessel; and delivering a fire-suppression composition from the interior of the vessel through the flow path to contact at least one of a fire and a source of fire, wherein the fire-suppression composition comprises a fibrous clay mineral and a propellant gas.

Statement 12. The method of statement 11 wherein the fibrous clay mineral is selected from the group consisting of sepiolite, palygorskite, attapulgite, and combinations thereof, and wherein the fibrous clay mineral has a d50 particle size ranging from about 10 microns to about 600 microns.

Statement 13. The method of any of statements 11 or 12 wherein the fire-suppression composition further comprises at least one component selected from the group consisting of bentonite, aluminum hydroxide, and combinations thereof.

Statement 14. The method of any of statements 11-13 wherein the propellant gas is selected from the group consisting of nitrogen, carbon dioxide, a noble gas, helium, and combinations thereof.

Statement 15. The method of any of statements 11-14 wherein the fire-suppression composition further comprises a flow agent selected from the group consisting of silica, sodium silicate, calcium silicate, tricalcium phosphate, sodium bicarbonate, potassium bicarbonate, magnesium trisilicate, talc, sodium aluminosilicate, potassium aluminosilicate, calcium aluminosilicate, aluminum silicate, polydimethylsiloxane, and combinations thereof.

Statement 16. The method of any of statements 11-15 wherein the fire-suppression composition further comprises a dry powder fire suppressant additive selected from the group consisting of alkali metal bicarbonate, potassium chloride, ammonium phosphate, calcium phosphate, an addition product of urea with an alkali metal bicarbonate, a silicone, mica, and combinations thereof.

Statement 17. A composition comprising: a powder comprising: a fibrous clay mineral bentonite; and aluminum hydroxide; and a propellant gas.

Statement 18. The composition of statement 17 wherein the fibrous clay mineral is selected from the group consisting of sepiolite, palygorskite, attapulgite, and combinations thereof, wherein the fibrous clay mineral is present in an amount of about 50% to about 99.99 wt. % based on a total weight of the powder, wherein the bentonite is present in an amount of about 5 wt. % to about 20 wt. % based on the total weight of the powder, and wherein the aluminum hydroxide is present in an amount of about 5 wt. % to about 50 wt. % based on the total weight of the powder.

Statement 19. The composition of any of statements 17 or 18 wherein each of the fibrous clay mineral, the bentonite, and the aluminum hydroxide individually have d50 particle sizes ranging from about 10 microns to about 600 microns.

Statement 20. The composition of any of statements 17-19 wherein the propellant gas is selected from the group consisting of nitrogen, carbon dioxide, a noble gas, helium, and combinations thereof.

### EXAMPLE

To facilitate a better understanding of the present embodiments, the following examples of certain aspects of some embodiments are given. In no way should the following examples be read to limit, or define, the entire scope of the embodiments.

### Example 1

A flowability limit test was performed as described herein. The test was performed to determine the difference in flowablility characteristics between equivalent masses of bentonite and a fibrous clay mineral, sepiolite, through a funnel. A sample was determined to be flowable if the bulk of the sample was able to flow out of the funnel without becoming packed in and stop flowing. A funnel was stoppered such that no sample could flow out of the funnel. A measured amount of sample was poured into the funnel and the stopper removed thereafter. Each mineral sample was tested three times and the flowability of each trial was observed and determined to flow (Y) or not flow (N). A specific mass at which flow ability was no longer observed was determined for each mineral when a specific mass was observed to not flow (N) with all three successive trials. The results of the test are tabulated in Table 1. It was observed that bentonite was flowable up to 150 grams. It was further observed that sepiolite was flowable up to 500 grams. The variability in flowability may be attributed to each samples tendency to become packed and stop flowing.

TABLE 1

| | | 50 g | 100 g | 150 g | 200 g | 250 g | 300 g | 350 g | 400 g | 450 g | 500 g | 550 g |
|---|---|---|---|---|---|---|---|---|---|---|---|---|
| Bentonite | Trial #1 | Y | N | N | N | — | — | — | — | — | — | — |
| | Trial #2 | Y | N | Y | N | — | — | — | — | — | — | — |
| | Trial #3 | Y | Y | N | N | — | — | — | — | — | — | — |
| Sepiolite | Trial #1 | Y | Y | Y | Y | Y | Y | Y | Y | N | N | N |
| | Trial #2 | Y | Y | Y | Y | Y | Y | Y | N | Y | N | N |
| | Trial #3 | Y | Y | Y | Y | Y | Y | Y | Y | N | Y | N |

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. An apparatus comprising:
a vessel;
a fire-suppression composition disposed within the vessel, wherein the fire-suppression composition comprises a fibrous clay mineral and a propellant gas; and
a valve disposed on an outlet of the vessel wherein the valve has at least an open position with a flow path between an interior of the vessel and an exterior of the vessel and a closed position wherein the flow path is blocked.

2. The apparatus of claim 1 wherein the fibrous clay mineral is selected from the group consisting of sepiolite, palygorskite, attapulgite, and combinations thereof.

3. The apparatus of claim 1 wherein the fibrous clay mineral has a d50 particle size ranging from about 10 microns to about 600 microns.

4. The apparatus of claim 1 wherein the propellant gas is selected from the group consisting of nitrogen, carbon dioxide, a noble gas, helium, and combinations thereof, and wherein the propellant gas is at a pressure ranging from about 500 kPa to about 6000 kPa.

5. The apparatus of claim 1 wherein the fire-suppression composition further comprises bentonite.

6. The apparatus of claim 5 wherein the bentonite has a d50 particle size at a point ranging from about 10 microns to about 600 microns.

7. The apparatus of claim 1 wherein the fire-suppression composition further comprises aluminum hydroxide, wherein the aluminum hydroxide has a d50 particle size at a point ranging from about 10 microns to about 600 microns.

8. The apparatus of claim 1 wherein the fibrous clay mineral comprises sepiolite, wherein the sepiolite has a d50 particle size ranging from about 20 microns to about 200 microns, and wherein the propellant gas is nitrogen or carbon dioxide.

9. The apparatus of claim 1 wherein the fire-suppression composition further comprises a flow agent selected from the group consisting of silica, sodium silicate, calcium silicate, tricalcium phosphate, sodium bicarbonate, potassium bicarbonate, magnesium trisilicate, talc, sodium aluminosilicate, potassium aluminosilicate, calcium aluminosilicate, aluminum silicate, polydimethylsiloxane, and combinations thereof.

10. The apparatus of claim 1 wherein the fire-suppression composition further comprises a dry powder fire suppressant additive selected from the group consisting of alkali metal bicarbonate, potassium chloride, ammonium phosphate, calcium phosphate, an addition product of urea with an alkali metal bicarbonate, a silicone, mica, and combinations thereof.

11. A method comprising:
actuating a valve to open a flow path between an interior of a vessel and an exterior of the vessel; and
delivering a fire-suppression composition from the interior of the vessel through the flow path to contact at least one of a fire and a source of fire, wherein the fire-suppression composition comprises a fibrous clay mineral and a propellant gas.

12. The method of claim 11 wherein the fibrous clay mineral is selected from the group consisting of sepiolite, palygorskite, attapulgite, and combinations thereof, and wherein the fibrous clay mineral has a d50 particle size ranging from about 10 microns to about 600 microns.

13. The method of claim 11 wherein the fire-suppression composition further comprises at least one component selected from the group consisting of bentonite, aluminum hydroxide, and combinations thereof.

14. The method of claim 11 wherein the propellant gas is selected from the group consisting of nitrogen, carbon dioxide, a noble gas, helium, and combinations thereof.

15. The method of claim 11 wherein the fire-suppression composition further comprises a flow agent selected from the group consisting of silica, sodium silicate, calcium silicate, tricalcium phosphate, sodium bicarbonate, potassium bicarbonate, magnesium trisilicate, talc, sodium aluminosilicate, potassium aluminosilicate, calcium aluminosilicate, aluminum silicate, polydimethylsiloxane, and combinations thereof.

16. The method of claim 11 wherein the fire-suppression composition further comprises a dry powder fire suppressant additive selected from the group consisting of alkali metal bicarbonate, potassium chloride, ammonium phosphate, calcium phosphate, an addition product of urea with an alkali metal bicarbonate, a silicone, mica, and combinations thereof.

17. A composition comprising:
a powder comprising:
a fibrous clay mineral
bentonite; and
aluminum hydroxide; and
a propellant gas.

18. The composition of claim 17 wherein the fibrous clay mineral is selected from the group consisting of sepiolite, palygorskite, attapulgite, and combinations thereof, wherein the fibrous clay mineral is present in an amount of about 50% to about 99.99 wt. % based on a total weight of the powder, wherein the bentonite is present in an amount of about 5 wt. % to about 20 wt. % based on the total weight of the powder, and wherein the aluminum hydroxide is present in an amount of about 5 wt. % to about 50 wt. % based on the total weight of the powder.

19. The composition of claim 17 wherein each of the fibrous clay mineral, the bentonite, and the aluminum hydroxide individually have d50 particle sizes ranging from about 10 microns to about 600 microns.

20. The composition of claim 17 wherein the propellant gas is selected from the group consisting of nitrogen, carbon dioxide, a noble gas, helium, and combinations thereof.
